(19) United States
(12) Patent Application Publication
(10) Pub. No.: US 2010/0250737 A1
(43) Pub. Date: Sep. 30, 2010

(54) DETECTING AND CONTROLLING PEER-TO-PEER TRAFFIC

(75) Inventors: Anat Bremler-Barr, Ramat Hasharon (IL); Hanoch Levin (Levy), Tel Aviv (IL); Omer Dekel, Gladwyne, PA (US)

Correspondence Address: D. Kligler I.P. Services LTD, P.O. Box 25, Zippori, 17910, IL

(73) Assignees: INTERDISCIPLINARY CENTER HERZLIYA, Herzliya (IL); ETH ZURICH, Zurich (CH); RAMOT AT TEL AVIV UNIVERSITY LTD, Tel Aviv (IL)

(21) Appl. No.: 12/739,738

(22) PCT Filed: Oct. 30, 2008
(86) PCT No.: PCT/IL2008/001433

§ 371 Date: Apr. 25, 2010

Related U.S. Application Data
(60) Provisional application No. 61/001,401, filed on Oct. 31, 2007.

(51) Int. Cl. G06F 15/16; G06F 15/173

(52) U.S. Cl. 709/224; 709/229

(57) ABSTRACT

A method for communication management includes detecting addresses of peer nodes (34) belonging to a service layer (30) of a distributed application running on a computer network (22). Responsively to the detected addresses, filtering of communication traffic transmitted by client computers (26) is actuated so as to limit access by the client computers to the distributed application.

### CROSS-REFERENCE TO RELATED APPLICATION

This application claims the benefit of U.S. Provisional Patent Application 61/001,401, filed Oct. 31, 2007, which is incorporated herein by reference.

### FIELD OF THE INVENTION

The present invention relates generally to computer network communications, and specifically to network traffic classification and control.

### BACKGROUND OF THE INVENTION

Peer-to-peer (P2P) applications, such as file sharing and voice-over-Internet-Protocol (VoIP) services, have come to dominate traffic on the Internet. By some estimates, P2P applications account for more than 50% of current Internet traffic. The bandwidth taken up by P2P traffic causes congestion and often degrades the quality of service (QoS) of other network applications. Internet service providers (ISPs) therefore have an interest in identifying and filtering P2P traffic in order to free up bandwidth for other applications and services.

One of the most popular P2P applications is Skype™, which has revolutionized the field of VoIP. Skype provides VoIP and related telephony services over the Internet, as well as video communications, messaging and file transfer, reliably, simply and for free. Despite its massive popularity, however, little is known about Skype's inner workings. Skype is a closed-source application, which uses proprietary protocols, variable port choice, and strong encryption in its communication traffic. Therefore, attempts to develop tools that can reliably identify and filter Skype traffic have so far met with only limited success.

Most known methods for detecting Skype traffic (and other types of P2P traffic) use packet signatures or statistical pattern classification. These sorts of techniques are described, for example, by Bonfiglio et al., in “Revealing Skype Traffic When Randomness Plays with You,” SIGCOMM '07 (Kyoto, Japan, August, 2007). The authors describe one approach in which they used a Chi-Square test to detect Skype's fingerprint from the packet framing structure. In another approach, they used stochastic characterization of Skype traffic in terms of packet arrival rate and packet length as features of a Bayesian decision process.

### SUMMARY

The embodiments of the present invention that are described hereinbelow provide new methods and systems for detecting network traffic belonging to distributed applications, including particularly P2P applications. These methods are directed specifically at identifying peer nodes that belong to the service layer of the target application, such as Skype “super nodes.” Once these nodes have been identified, it is possible to filter traffic to and/or from these nodes and thus block or reduce substantially access by client computers to the target application. These methods of identifying and filtering certain application traffic may be used on their own or in combination with other methods of application traffic control, such as signature- and pattern-based methods.

There is therefore provided, in accordance with an embodiment of the present invention, a method for communication management, including detecting addresses of peer nodes belonging to a service layer of a distributed application running on a computer network. Responsively to the detected addresses, filtering of communication traffic transmitted by client computers is actuated so as to limit access by the client computers to the distributed application.

There is also provided, in accordance with an embodiment of the present invention, a method for communication management, including running a client version of the distributed application on a collecting computer, wherein the client version causes the collecting computer to download a first list of addresses of nodes serving the distributed application. After downloading the first list, the client version of the distributed application that is running on the collecting computer is prevented (by the method) from accessing at least some of the addresses on the first list, so as to cause a second list of the addresses, different from the first list, to be downloaded from the service layer to the collecting computer. At least the first and second lists are combined to generate a master list of the addresses of the nodes serving the distributed application.

There is additionally provided, in accordance with an embodiment of the present invention, apparatus for communication management, including a network interface, for connection to a computer network, and a processor, which is coupled to the network interface. The processor is configured to collect addresses of peer nodes belonging to a service layer of a distributed application running on the computer network, and to actuate filtering, responsively to the detected addresses, of communication traffic transmitted by client computers so as to limit access by the client computers to the distributed application.

There is further provided, in accordance with an embodiment of the present invention, a computer software product, including a computer-readable medium in which program instructions are stored, which instructions, when read by a computer, cause the computer to detect addresses of peer nodes belonging to a service layer of a distributed application running on a computer network and responsively to the detected addresses, to cause communication traffic transmitted by client computers to be filtered so as to limit access by the client computers to the distributed application.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a packet communication system, in accordance with an embodiment of the present invention; and

FIG. 2 is a flow chart that schematically illustrates a method for identifying and filtering traffic associated with a distributed application, in accordance with an embodiment of the present invention.

### DETAILED DESCRIPTION OF EMBODIMENTS

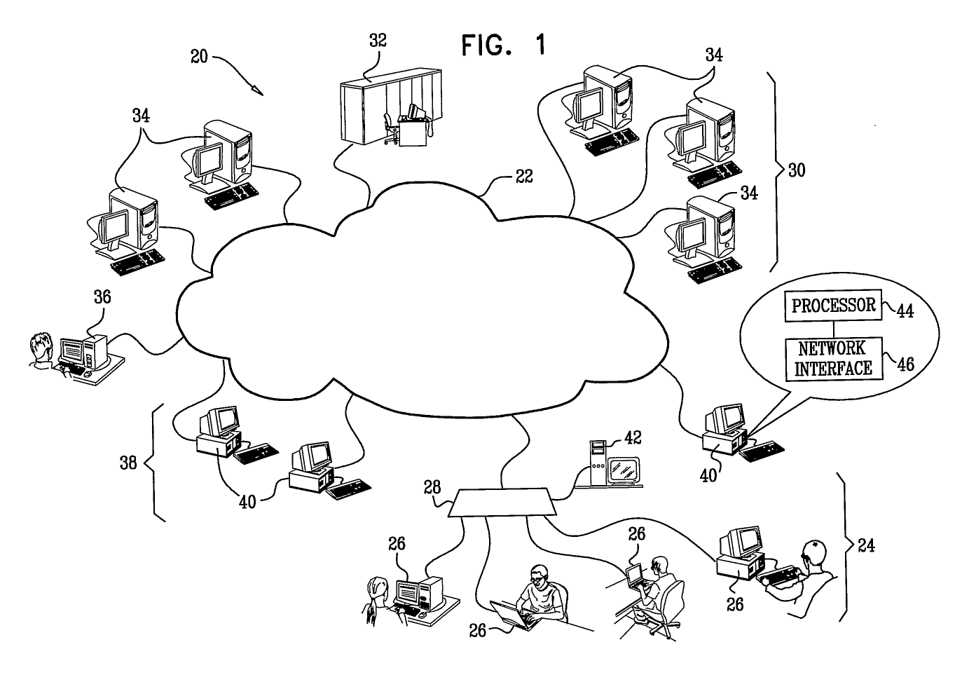

FIG. 1 is a schematic, pictorial illustration of a packet communication system 20, in accordance with an embodiment of the present invention. System 20 is built around a wide-area network 22, typically a public network such as the Internet. Client computers 26 typically access public network 22 through a local network 24, which is connected to the public network by an access concentrator 28. Local network 24 may comprise, for example, an access network operated by an ISP or an enterprise network belonging to an organization. Access concentrator 28 is shown in FIG. 1 as a single unit but typically comprises an array of routers and other switches, as well as ancillary equipment, such as a firewall. Although the present embodiment is described, for the sake of simplicity, with reference to the abstract network architecture that is shown in FIG. 1, the principles of this embodiment may readily be applied in substantially any sort of network configuration that is known in the art.

Users of client computers 26 may typically attempt to access distributed applications running on network 22. The term “distributed applications,” as used in the context of the present patent application and in the claims, refers to applications made up of distinct components that run concurrently on different and separate computer systems connected to the network (in contrast to ordinary client-server applications, in which the server resides on a single computer system). P2P applications are one type of distributed application, in which application traffic passes directly between client computers, referred to as “peer nodes” (sometimes shortened simply to “peers”), rather than via a server. The present embodiment relates specifically to Skype, as an archetypal example of a P2P application, but the principles of the present invention may similarly be applied, mutatis mutandis, to other types of distributed applications and especially P2P applications.

In order to use a Skype application, a client computer 26 must first connect to a computer node in a service layer 30 of the application. The “service layer,” in the context of the present patent application and in the claims, refers to a specific subset of the nodes participating in a distributed application that is responsible for management functions, including particularly client login and authentication. The service layer may also perform other functions, including collecting and distributing meta-information relating to management of the application, such as the addresses and status (active/inactive) of service layer nodes and clients or the locations of files in a P2P file sharing network. This sort of management traffic is distinct from the actual application traffic, such as voice, image, or file transfer packets, that is exchanged between client nodes in a P2P application, for instance.

In the case of Skype, for example, service layer 30 is known to comprise at least one login server 32 and super nodes (SNs) 34. The SNs are ordinary client (peer) nodes that are chosen by Skype to be part of the service layer. The SNs maintain an overlay network among themselves in order to allow the clients to communicate and establish calls. The criteria according to which Skype chooses SNs are not publicly known, nor does Skype inform clients that they have been chosen to serve as SNs. It appears that the choice of SNs is dynamic, so that a given client may be a SN at some times but not others. Thus, although SNs 34 are shown in FIG. 1, for the sake of clarity and simplicity, as a single, distinct group, in fact the SNs are typically distributed at different locations around the world and are, from the users' point of view, almost indistinguishable from ordinary client nodes.

In order to connect to the Skype application network, client computer 26 first establishes a connection to one of SNs 34, based on a list of SNs that was previously stored on the client computer. After connecting to one of the SNs, the client computer authenticates itself against records held by login server 32. The SN relays the login request to the server, which then permits the authenticated client to connect to the Skype network.

After connecting to one of the SNs and completing authentication, client computers can communicate among themselves. In order to connect to the user of a client computer 36, for example, computer 26 queries its associated SN 34 regarding the availability and IP address of the destination client. When computer 26 gets the answer, it attempts to connect directly to destination computer 36. If it is not possible to establish a direct connection between the client computers, the communication may be routed via one or more SNs 34. This approach is capable of bypassing firewalls and proxy servers.

When a fresh copy of the Skype application is installed on client computer 26, the computer receives a list of hard-coded addresses of fixed service layer nodes, such as server 32, to which it may connect initially. After successfully connecting for the first time, the client computer receives and maintains a list of addresses (IP address and port) of available SNs. This list, which typically contains the addresses of about 200 different SNs, is updated continually as long as the client computer is connected. Using Skype versions 2-2.5, the inventors observed that an average of 6% of the addresses on the list are changed per hour. When the list is removed from the client computer, however, the computer downloads a new list, in which approximately 75% of the addresses are new. (In the context of the present patent application and in the claims, the term “address” means the set of one or more identifiers of a given network node, such as the IP address and port number, that are needed in order to establish a network connection with that node for purposes of the distributed application in question.)

As noted earlier, the operator of local network 24 may wish to limit the network resources that are consumed by a certain target application, such as Skype, in order to improve QoS for other applications, increase use of paid services offered by the operator, or reduce security breaches that the target application may engender. For this purpose, the network operator may deploy a traffic control system 38, whose operation is described in detail hereinbelow. The aim of system 38 is to distinguish the communication traffic of the target application from other traffic in order to filter the target application traffic. “Filtering,” in the context of the present patent application and in the claims, means any sort of treatment that is directed to reducing or otherwise modifying the relative amount of network resources that are consumed by the target application. Thus, filtering in this context may comprise blocking the target application traffic in network 24. Alternatively or additionally, filtering the target application traffic may mean assigning this traffic a low priority or otherwise limiting its transmission rate. This filtering may be applied only during certain periods, such as periods of network congestion, or at all times.

Traffic control system 38 comprises one or more collecting units 40, which learn the topology of service layer 30 of the target application, and means for filtering target application traffic, actuated by information provided by the collecting units. This filtering may be carried out by or under the control of one or more control units 42. Although the collecting units and control unit are shown in FIG. 1 as separate physical entities, in some embodiments the collecting and control functions of system 38 may be carried out by a single entity, such as a computer with suitable communications and control capabilities. More typically, however, the collecting units are separate from the control units or other filtering means and may even be operated by different organizations. For example, a single collecting service, which operates a number of collecting units, may provide and distribute filtering information to multiple access networks.

Collecting units 40 typically comprise general-purpose computers, which comprise a network interface 46, connected to network 22, and a processor 44, which runs a client version of the target application. For example, a standard, version of the Skype client program may be installed on each collecting unit. The collecting units may be maintained in a single location or distributed over multiple locations, as shown in FIG. 1. The collecting units also run an address-collection software routine, which causes the client program to repeatedly request new information about the service layer and harvests the addresses of service layer nodes that are provided to the client program. Specifically, in the case of Skype, the routine causes the collecting units to repeatedly request new lists of SNs. Thus, each collecting unit will accumulate a long list of SN addresses, and these lists may be collated into a master list by one of the collecting units or by another computer.

In some distributed application architectures, clients can connect only to certain sub-groups of service layer nodes. The sub-group assignment typically depends on some characteristic of the client (such as country or IP address) or a client identifier (which may be coded in the client software). In such cases, the collecting unit may be tailored to the specific network in which the traffic is to be filtered. For example, if clients can connect only to SNs belonging to the same country as the client, the collecting units can be deployed in every country in which filtering is mandated. Thus, to filter P2P traffic in a network that is located partly in Israel and partly in the United States, for instance, the set of collecting units will contain clients in both Israel and the United States.

As noted above, various different means may be used to identify and filter the target application traffic based on the list of addresses provided by the collecting units. In the pictured embodiment, these identification and filtering functions are performed or coordinated by control unit 42. This control unit may comprise a general-purpose computer, which is programmed in software to generate instructions to access concentrator 28. Alternatively or additionally, the functions of identifying and filtering target application traffic may be integrated into elements of the access concentrator itself, such as firewalls, routers, gateways, or other intrusion detection and intrusion prevention systems. Further alternatively or additionally, a dedicated hardware unit may be deployed for performing the traffic identification and filtering functions that are described herein.

The software that drives the collecting units, as well as other components of system 38, may be downloaded to these components in electronic form, over a network, for example. Alternatively or additionally, the software may be provided on tangible media, such as optical, magnetic or electronic memory media.

In a typical embodiment, control unit 42 defines as target application traffic any packets whose destination address (meaning, in the present embodiment, the destination IP address and port number) appears on the list of SN addresses, and instructs access concentrator 28 to apply predefined filtering rules to this traffic. (In some cases, traffic whose source address appears on the list is also blocked.) Thus, for example, the control unit may determine that any outgoing packets from client computers 26 to SNs 34 should be blocked. As a result, if the list of SN addresses assembled by collecting units 40 is complete, the client computers on network 24 will be entirely unable to communicate with service layer 30 and will thus be prevented from accessing the target application. (The address of server 32, as well as of any other element of service layer 30 or of the target application in general that is discovered by system 38, may likewise be added to the list of addresses to be filtered.) Even if the list is not 100% complete, the ability of client computers 26 to access the application will still be inhibited.

Furthermore, control unit 42 may use the management traffic transmitted between any of client computers 26 and service layer 30 to identify and filter target application traffic transmitted between that client computer 26 and other clients, such as computer 36, that are not in the service layer. This approach is described further hereinbelow.

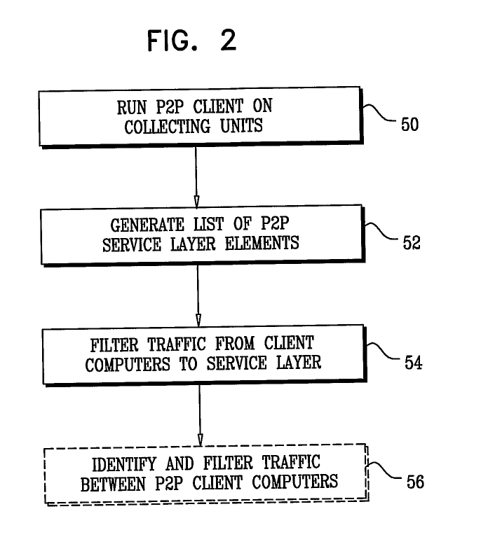

FIG. 2 is a flow chart that schematically illustrates a method for identifying and filtering traffic associated with a distributed application, in accordance with an embodiment of the present invention. The method will be described, for the sake of convenience, with reference to Skype and to the system configuration shown in FIG. 1, but it may similarly be applied to other applications and in other configurations.

Collecting units 40 download, install and run Skype client software, at a client running step 50. The collecting units use the client software to generate a list of addresses of the nodes in service layer 30, at a list generation step 52. As noted above, the addresses typically include both the IP address and port for each SN 34 (so as to enable control unit 42 to block only traffic belonging specifically to the target application and avoid blocking other traffic on other ports that happens to be directed to the same IP address). Various techniques may be used to assemble the list of addresses from the client program. Two of these techniques are described below:

### 1) Extracting the SN List

This technique uses the fact that in Skype versions 2-2.5, each client holds a list of up to 200 SN addresses in a specific XML file: %appdata%\Skype\shared.xml. Each collecting unit 40 repeatedly performs the following steps:
1. Extract the SN addresses from the XML file;
2. Flush most of the SN addresses from the list, leaving only certain specific SNs
3. Restart the Skype client and wait for the list to be refreshed with 200 more SN addresses.
   Each such iteration was found to take approximately 2-2.5 minutes. In order to harvest the entire set of active SNs, the inventors used clusters of dozens of computers, all collecting the SN addresses concurrently.

Skype also uses a number of “bootstrap SNs,” which do not necessarily appear in the XML file. To discover the addresses of these additional SNs, the collecting unit may monitor the preliminary connection attempts of a newly-installed client program, using the monitoring techniques that are described in the next section. The addresses of the bootstrap SNs are added to the list.

### 2) Monitoring Skype Connections

An alternative technique for collecting SN addresses is based on observing outbound connections established by the Skype client program running on the collecting units. This technique is needed particularly for more recent versions of Skype, in which the SN list is encrypted, but will also work with earlier versions of the program. Various software and hardware monitoring tools may be used for this purpose. For example, the netstat command (“netstat -b -n -o”) causes the collecting computer to list its active connections (IP address, port), along with an indication of the application that was responsible for opening the connection. As another example, the NetFlow feature of routers produced by Cisco Systems Inc. (or similar features on routers offered by other vendors) can be used to collect records of network connections made by the collecting units. As long as the collecting units are not running any communication applications other than Skype, the addresses collected by NetFlow are guaranteed to be SN addresses.

Thus, in the present embodiment, collecting unit 40 repeatedly performs the following steps:
1. Initiate connection of the Skype client program to service layer 30;
2. Use netstat (or other means, such as a packet sniffer) to identify the address of the SN to which the client has connected, and add the address to the list of collected addresses;
3. Block the address of identified SNs (using a local or external firewall, for example)—which will force the client program to switch to another SN;
4. Repeat steps 2 and 3 until a sufficient number of SN addresses has been collected;
5. Erase the internal list held by the client program and wait for the list to be refreshed with more SN addresses. (In Skype, as well as most other applications, the list is contained in its own file, and thus can be easily identified and erased.)
   Even without erasing the SN list, it is still generally possible to receive a new pool of SNs, for example by blocking all of the SN addresses but one, so that the non-blocked SN can download a new list to the collecting unit.

The inventors found that using this second technique, a given collecting unit was able to collect thirty new SN addresses per minute. With a cluster of seventy-seven computers serving as collecting units, the inventors collected over 100,000 SN addresses. (An equivalent sort of result could be achieved by running multiple Skype client programs concurrently on each collecting computer, thus reducing the number of actual computers required.) Although system 38 in FIG. 1 includes only a single access concentrator 28 and control unit 42, in general a set of collecting units can provide SN address lists to multiple control units at different sites, for filtering Skype traffic on multiple different local networks.

Returning now to FIG. 2, control unit 42 receives the list of SN addresses from collecting units 40. The control unit uses the list in filtering packets transmitted from client computers 26 to service layer 30, and possibly also filtering packets from the service layer to the client computers, at a filtering step 54.

If the list of SN addresses assembled at step 52 is complete, it will then be possible to block Skype communications by client computers 26 completely, as well, after a few hours of address collection that are needed to complete the list. In practice, however, the set of SNs used by Skype is dynamic: For example, SNs may leave or rejoin the network, SNs may change addresses due to dynamic IP address allocation, and the Skype servers may choose to add new SNs for various reasons. Therefore, it is desirable that collecting units 40 repeat step 52 continually in order to keep the list of SN addresses up to date. In this case, there may always be some new SN addresses in service layer 30 that have not yet been included in the list used by control unit 42. Therefore, some client computers may still succeed in connecting to the service layer. Empirically, the inventors found that under typical dynamic conditions, it is still possible to block roughly 95% of the client computers' connection attempts. The actual blocking rate depends on the rapidity of change in the set of SNs 34 on the one hand and the rate at which collecting units 40 collect new SN addresses on the other.

Optionally, the information collected at step 52 may be used in identifying and filtering application traffic between client computers, such as between computers 26 and 36, at a traffic filtering step 56. For example, system 38 may identify active clients of an application, such as Skype, by detecting connections between the client computers and addresses on the SN address list. Having identified the active clients, Control unit 42 may then filter packets (i.e., block or limit the data rate of packets) transmitted to and/or from these clients.

This technique for identifying application traffic may be used in conjunction with other methods of detecting P2P and other traffic types, such as signature or pattern recognition. By themselves, these signature and pattern recognition techniques are often unreliable, and in particular tend to suffer from a high rate of false positive results, i.e., misidentifying “innocent” traffic as belonging to the target application and therefore filtering traffic that should not be filtered. By combining the address-based techniques described above with signature and/or pattern recognition, the overall reliability of identification and filtering of the target application traffic can be increased, with false positives reduced to nearly zero. Furthermore, the combination of address-based application recognition with signature or pattern recognition can be used to selectively filter only certain types of application traffic. For example, control unit 42 may be able to distinguish file transfer over Skype from VoIP traffic based on the different respective signatures of these traffic types, and to block file transfer while permitting VoIP communications (or vice versa).

Although the embodiments described above relate specifically to Skype, the principles of the present invention may similarly be applied to control client access to other distributed applications, and particularly P2P applications. Examples of such applications include Bittorrent, Emule, Gigaget, Gnutella, Kazaa, SOPCast, TVAnts and Joost, among others. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for communication management, comprising:
detecting addresses of peer nodes belonging to a service layer of a distributed application running on a computer network; and
responsively to the detected addresses, actuating filtering of communication traffic transmitted by client computers so as to limit access by the client computers to the distributed application.

2. The method according to claim 1, wherein detecting the addresses comprises running a client version of the distributed application on a collecting computer, wherein the client version causes the collecting computer to download a list of the addresses from the service layer.

3. The method according to claim 2, wherein detecting the addresses comprises monitoring outbound connections established by the client version of the distributed application that is running on the collecting computer.

4. The method according to claim 2, wherein detecting the addresses comprises, after downloading a first list of the addresses, preventing the client version of the distributed application that is running on the collecting computer from accessing at least some of the addresses on the first list, so as to cause a second list of the addresses, different from the first list, to be downloaded from the service layer to the collecting computer.

5. The method according to claim 4, wherein actuating the filtering comprises combining at least the first and second lists into a master list for use in filtering the communication traffic.

6. The method according to claim 5, wherein the service layer comprises at least one fixed server, and wherein the method comprises detecting an address of the at least one fixed server, and adding the detected address to the master list.

7. The method according to claim 4, wherein preventing the client version from accessing at least some of the addresses comprises removing the at least some of the addresses from the first list held by the collecting computer.

8. The method according to claim 4, wherein preventing the client version from accessing at least some of the addresses comprises blocking transmission of data packets between the collecting computer and the at least some of the network addresses.

9. The method according to claim 2, wherein the peer nodes in the service layer belong to multiple sub-groups, which serve different, respective groups of clients, and wherein running the client version comprises deploying one or more collecting computers in each of two or more of the groups of the clients.

10. The method according to claim 1, wherein the addresses comprise Internet Protocol (IP) addresses and ports associated respectively with the distributed application on the peer nodes at the IP addresses.

11. The method according to claim 1, wherein the filtering of the communication traffic comprises blocking data packets transmitted by the client computers to the detected addresses.

12. The method according to claim 1, wherein the filtering of the communication traffic comprises identifying and filtering application data packets associated with the distributed application that are transmitted between the client computers.

13. The method according to claim 1, wherein the distributed application comprises a peer-to-peer (P2P) application.

14. The method according to claim 12, wherein the P2P application comprises a voice-over-Internet-Protocol (VoIP) application.

15. A method for communication management, comprising:
running a client version of the distributed application on a collecting computer, wherein the client version causes the collecting computer to download a first list of addresses of nodes serving the distributed application;
after downloading the first list, preventing the client version of the distributed application that is running on the collecting computer from accessing at least some of the addresses on the first list, so as to cause a second list of the addresses, different from the first list, to be downloaded from the service layer to the collecting computer; and
combining at least the first and second lists to generate a master list of the addresses of the nodes serving the distributed application.

16. The method according to claim 15, and comprising controlling access by client computers to the distributed application using the master list.

17. Apparatus for communication management, comprising:
a network interface, for connection to a computer network; and
a processor, which is coupled to the network interface and is configured to collect addresses of peer nodes belonging to a service layer of a distributed application running on the computer network, and to actuate filtering, responsively to the detected addresses, of communication traffic transmitted by client computers so as to limit access by the client computers to the distributed application.

18. The apparatus according to claim 17, wherein the processor is configured to run a client version of the distributed application, wherein the client version causes the processor to download a list of the addresses from the service layer.

19. The apparatus according to claim 17, and comprising one or more control units, which are configured to block data packets transmitted by the client computers to the detected addresses.

20. A computer software product, comprising a computer-readable medium in which program instructions are stored, which instructions, when read by a computer, cause the computer to detect addresses of peer nodes belonging to a service layer of a distributed application running on a computer network and responsively to the detected addresses, to cause communication traffic transmitted by client computers to be filtered so as to limit access by the client computers to the distributed application.
